(19) United States
(12) Patent Application Publication
(10) Pub. No.: US 2019/0318855 A1
(43) Pub. Date: Oct. 17, 2019

(54) SINTERABLE MAGNETIC POWDER COMPOSITION AND THREE-DIMENSIONAL OBJECT MANUFACTURED BY SINTERING SUCH A COMPOSITION

(71) Applicant: Arkema France, Colombes Cedex (FR)

(72) Inventors: Arnaud LEMAITRE, Saint Martin - Saint Firmin (FR); François TANGUY, Mantes-La-Jolie (FR)

(73) Assignee: Arkema France, Colombes Cedex (FR)

(21) Appl. No.: 16/461,969

(22) PCT Filed: Nov. 20, 2017
(86) PCT No.: PCT/FR2017/053176

§ 371 Date: May 17, 2019

(30) Foreign Application Priority Data
Nov. 18, 2016 (FR) 16.61250

(51) Int. Cl. H01F 1/08; H01F 1/113; B22F 1/00; B22F 3/105; B22F 9/04

(52) U.S. Cl. CPC H01F 1/086; H01F 1/113; B22F 1/0014; B22F 2302/35; B22F 3/1055; B22F 9/04; B22F 1/0059

(57) ABSTRACT

A sinterable magnetic powder composition including: from 50 to 95% of a powder magnet; and from 5 to 50% by weight of at least one thermoplastic polymer; for the total weight of the composition, said powder composition having a D50 comprised within the range of 0.1 to 100 μm. And, to the use of the composition in processes used to agglomerate powders, layer by layer, by melting or sintering, for manufacturing three-dimensional magnetic objects.

The present invention relates to a magnetic powder composition and its use in processes used to agglomerate powders, layer by layer, by melting or sintering, for manufacturing three-dimensional magnetic objects.

“Magnetic objects” within the meaning of the invention refers to objects with intrinsic coercivity Hci=1 to 15 kOe; and/or Remanence Br=0.3 to 1.8 T. The agglomeration of powders by melting (hereinafter referred to as “sintering”) is caused by radiation such as, for example, a laser beam (laser sintering), infra-red radiation, UV radiation or any source of electromagnetic radiation enabling the powder to be melted layer by layer in order to manufacture objects. The technology for manufacturing objects layer by layer is described in particular in parent application WO2009138692 (pages 1 to 3). This technology is typically used to produce prototypes, to model parts (“rapid prototyping”) or to produce finished parts in small series (“rapid manufacturing”), for example in the automotive, nautical, aeronautical, aerospace, medical (prostheses, hearing aids, cellular tissues, etc.), textile, clothing, fashion, decoration, electronics housings, telephony, home automation, computer, and lighting industries.

The present invention more particularly relates to the market for automotive parts, electrical appliances, computers, electronics, microelectronics, and other advanced technologies.

For these markets, permanent magnets made from rare earths are considered strategic materials. Rare earths are a group of metals with similar properties including scandium, yttrium and 15 lanthanides such as neodymium and samarium. Neodymium, for example, is used to make powerful magnets for electric motors of any size, as well as those that operate the read and write heads of hard disks, or those used in hybrid cars, or in even wind turbines. High-performance permanent magnets include those made with neodymium which are known as NdFeB magnets, NIB magnets and Neo magnets. They are comprised of an alloy of neodymium (Nd), iron (Fe) and boron (e.g. Nd2Fe14B).

Today, there are two ways to obtain permanent magnets:
By laser sintering of pure metal: this method, which relies on very high temperatures, is therefore very expensive. The parts obtained have limited mechanical properties and limited resistance to oxidation.
By compounding with a thermoplastic or, optionally, a thermoset, then injection or compression to obtain the finished part. The magnetic properties are lower, but the resulting mechanical properties (impact resistance, bending etc.) enable new applications.

In these markets, thermoplastic polymers (hereinafter TPs) are therefore usually chosen for their mechanical properties, in particular impact resistance and flexibility, and for their physical and chemical resistance. These thermoplastic polymers are easy to implement using the conventional methods of injection, extrusion, moulding and/or assembly.

There is thus a real demand for magnetic materials combining the mechanical properties of TPs and the magnetic properties of magnets, while having a complex geometry, and requiring the lowest possible development time. Layered sintering processes provide a way to meet this demand, but they require specific prior processing of these TPs and magnets, in the form of powders.

The present invention therefore aims to provide suitable magnetic powders for use in sintering devices and to enable the manufacture of parts, even those having complex geometry, with satisfactory properties, particularly in terms of density and mechanical and magnetic properties.

The present invention also aims to provide a method for manufacturing magnets that are dense and have good resolution and mechanical properties, directly by sintering.

The present invention thus relates to a sinterable magnetic powder composition comprising:
from 50 to 95% of a powder magnet;
from 5 to 50% by weight of at least one thermoplastic polymer; for the total weight of the composition,
   said powder composition having a D50 of less than 100 μm.

If the magnetic particle content is less than 50% by weight, it may be difficult to obtain the desired magnetic properties. If the magnetic particle content is greater than 95% by weight, the sintered articles obtained from the sinterable magnetic powder composition in the invention tend to have a lower mechanical strength, and recycling the sinterable magnetic powder tends to be more difficult or even impossible.

Advantageously, the composition according to the invention comprises from 0.1 to 5% by weight of a powdery flow aid with D50 less than 20 μm for the total weight of the composition.

The present invention also relates to a process for manufacturing a powder composition according to the invention, comprising the following steps:
a) mixing by compounding said at least one polymer with said at least one magnet;
b) grinding, including cryogrinding, the mixture obtained in a) to obtain a powder with a D50 of less than 100 μm and a yield greater than 50%;
c) optional addition of additives such as a flow aid, to the powder obtained in b).

In the method according to the invention, the yield greater than 50% in step b) is a yield by weight for the total weight of the initial amount of powder prior to grinding, and means that for 100 kg of powder ground, more than 50 kg of the powder obtained after grinding has a D50 of less than 100 μm.

The present invention also relates to the use of a powder composition according to the invention, with a D50 of less than 100 μm, to produce a magnetic object by sintering.

Advantageously, the object manufactured by sintering has the following properties:
D50 corresponds to the value of the particle size which divides the population of particles examined exactly in two. In other words, in the composition according to the invention, 50% of the particles have a size less than 100 μm. A D50 of less than 100 μm in the composition according to the invention is essential for obtaining an precisely-defined object with a surface that is smooth and seamless in appearance. The D50 is measured according to ISO standard 9276—Parts 1 to 6: “Representation of data obtained by granulometric analysis.” In the present description, a Sympatec Helos laser granulometer and Fraunhofer software were used to obtain the granulometric distribution of the powder and to deduce the D50 therefrom.

### I—Polymers

Examples of polymers suitable for the composition of the invention include polyamides (homopolyamides and copolyamides), polyolefins, epoxies and polyesters, epoxy/polyether hybrids, polyurethanes, block copolymers, and poly(arylene-ether-ketones).

“Polyamide” (homopolyamide or copolyamide known as “CoPA”) refers to the products of the condensation or polymerization of the same monomer (for the homopolyamides) or several different monomers (for the CoPAs), chosen among:
monomers such as amino acids or amino carboxylic acids, and preferably alpha, omega-aminocarboxylic acids;
monomers such as lactams comprising between 3 and 18 carbon atoms on the main ring and which can be substituted;
monomers such as “diamine-diacid” resulting from the reaction between an aliphatic diamine comprising between 4 and 18 carbon atoms, and a carboxylic diacid having between 4 and 18 carbon atoms; and
mixtures thereof, with monomers comprising a different number of carbon atoms in the case of copolyamides formed by mixtures between an amino acid type monomer and a lactam type monomer.

“Monomer” in the present description of copolyamides, is to be understood to mean “repeat unit.” Indeed, the case in which a repeat unit of the PA consists of the association of a diacid with a diamine is a particular one. The combination of a diamine and a diacid, i.e., the diamine-diacid pair (in equimolar amount), is considered to correspond to the monomer. This is explained by the fact that individually, the diacid or the diamine is only a structural unit, which alone is not enough to polymerise.

Amino Acid Type Monomers:

Examples of alpha, omega-amino acids include those comprising from 4 to 18 carbon atoms, such as aminocaproic acid, 7-aminoheptanoic acid, 11-aminoundecanoic acid, N-heptyl-11-aminoundecanoic acid and 12-aminododecanoic acid.

Lactam Type Monomers:

Examples of lactams can include those comprising from 3 to 18 carbon atoms on the main ring and which can be substituted. Examples are β,β-dimethylpropriolactam, α,α-dimethylpropriolactam, amylolactam, caprolactam also referred to as lactam 6, capryllactam also referred to as lactam 8, enantholactame, 2-pyrrolidone, and lauryllactam also referred to as lactam 12.

“Diamine-Dacid” Type Monomers:

Examples of dicarboxylic acid can include acid comprising between 4 to 18 carbon atoms. Examples can include adipic acid, sebacic acid, azelaic acid, suberic acid, isophthalic acid, butanedioic acid, 1,4 cyclohexyldicarboxylic acid, terephthalic acid, sulfoisophthalic acid sodium or lithium salt, dimerised fatty acids (these dimerised fatty acids have a dimer content of at least 98% and are preferably hydrogenated) and dodecanedioic acid HOOC-(CH2)10-COOH.

Examples of diamine can include aliphatic diamines having from 4 to 18 atoms, which can be arylic and/or saturated cyclic. Examples can include hexamethylenediamine, piperazine tetramethylenediamine, octamethylene diamine, decamethylene diamine, dodecamethylene diamine, 1,5 diaminohexane, 2,2,4-trimethyl-1,6-hexanediamine, diamine polyols, isophorone diamine (IPD), methylpentamethylene diamine (MPDM), bis(aminocyclohexyl)methane (BACM), bis(3-methyl-4 aminocyclohexyl)methane (BMACM), methaxylyenediamine, bis(p aminocyclohexyl)methane, and trimethylhexamethylene diamine.

Examples of “diamine-diacid”- type monomers include those resulting from the condensation of hexamethylene diamine with a diacid C6 to C36, in particular the monomers: 6.6, 6.10, 6.11, 6.12, 6.14, 6.18. This can include monomers resulting from the condensation of decanediamine with a diacid C6 to C36, particularly the monomers: 10.10, 10.12, 10.14, 10.18; or those resulting from the condensation of decanediamine with a terephthalic acid, i.e., monomer 10.T.

Examples of copolyamides formed from different types of monomers described above include copolyamides resulting from the condensation of at least two alpha, omega-aminocarboxylic acids or two lactams or one lactam and an alpha, omega-aminocarboxylic acid. These can also include copolyamides resulting from the condensation of at least one alpha, omega-aminocarboxylic acid (or a lactam), at least one diamine and at least one dicarboxylic acid. These may also include copolyamides resulting from the condensation of an aliphatic diamine with an aliphatic carboxylic diacid and at least one other monomer chosen from aliphatic diamines other than the preceding one and aliphatic diacids different from the preceding one.

Examples of copolyamides can include copolymers of caprolactam and lauryllactam (PA 6/12), copolymers of caprolactam, hexamethylene diamine and adipic acid (PA 6/6.6), copolymers of caprolactam, of lauryllactam, of hexamethylene diamine and of adipic acid (PA 6/12/6.6), copolymers of caprolactam, of hexamethylene diamine et azelaic acid, 11-aminoundecanoic acid, and of lauryllactam, (PA 6/6.9/11/12), copolymers of caprolactam, adipic acid and of hexamethylene diamine, 11-aminoundecanoic acid, of lauryllactam (PA 6/6.6/11/12), copolymers of hexamethylene diamine, azelaic acid, and of lauryllactam (PA 6.9/12), copolymers of 2-pyrrolidone and caprolactam (PA 4/6), copolymers of 2-pyrrolidone and lauryllactam (PA 4/12), copolymers of caprolactam and 11-aminoundecanoic acid (PA 6/11), copolymers of lauryllactam and of capryllactam (PA 12/8), copolymers of 11-aminoundecanoic acid and 2-pyrrolidone (PA11/4), copolymers of capryllactam and of caprolactam (PA 8/6), copolymers of capryllactam and of 2-pyrrolidone (PA 8/4), copolymers of lauryllactam and of capryllactam (PA 12/8), copolymers of lauryllactam and of 11-aminoundecanoic acid (PA 12/11).

Particularly preferred substances are polyamide 11 and polyamide 12, as well as polyamides and copolyamides using in particular monomers 6.10, 6.12, 6.14, 6.18, 10.10 and 10.12.

Preferred particle diameters are substantially near 100 μm (median D50 diameter).

“Polyolefins” means polymers comprising olefin units such as, for example, ethylene, propylene, butene-1, etc. Examples include:
Polyethylene, propylene, and ethylene copolymers comprising alpha-olefins. These products can be grafted with unsaturated carboxylic acid anhydrides such as maleic anhydride or unsaturated epoxides such as glycidyl methacrylate.
Ethylene copolymers comprising at least one product chosen from (i) the unsaturated carboxylic acids, their salts, their esters, (ii) the vinyl esters of saturated carboxylic acids, (iii) the unsaturated dicarboxylic acids, their salts, their esters, their monoesters, their anhydrides, (iv) the unsaturated epoxides. These ethylene copolymers may be grafted with anhydrides of unsaturated dicarboxylic acids or epoxides.

The poly(arylene ether ketone)s which can be used in the invention comprise units of formula IA, of formula IB and their mixture.

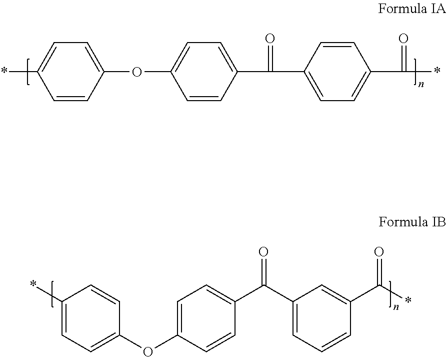

In a more general context, the poly(arylene ether ketone)s corresponding to the generic names PEK, PEEKEK, PEEK or PEKEKK (where E denotes an ether functional group and K a ketone functional group) cannot be excluded, in particular when their use takes place in combination with that of the PEKK in weight proportions in which the PEKK represents more than 50% in proportion by weight and preferably more than 80% in proportion by weight, limits included.

Preferably, the poly(arylene ether ketone)s are poly(ether ketone ketone)s comprising a mixture of IA and IB units, such that the percentage by weight of terephthalic units with respect to the sum of the terephthalic and isophthalic units is between 55% and 85% and preferably between 55% and 70%, ideally 60%. “Terephthalic” and “isophthalic” unit means the formula of the terephthalic acid and isophthalic acid, respectively.

These poly(arylene ether ketone)s are provided in the form of powders which can have been prepared by milling or precipitation.

“Block copolymer”, according to the invention, means thermoplastic elastomer (TPE) polymers, which comprise, in alternation, blocks or segments referred to as “hard” or “rigid” (behaving more like thermoplastics) and blocks or segments referred to as “soft” or “flexible” (behaving more like elastomers). A block is referred to as “soft” if it has a low vitreous transition temperature (Tg). “Low vitreous transition temperature” means a vitreous transition temperature Tg below 15° C., preferably below 0° C., advantageously below −15° C. and yet more advantageously below −30° C., or even below −50° C.

“Possible flexible or soft blocks in the copolymer according to the invention” means in particular those chosen from among the polyether blocks, polyester blocks, polysiloaxane blocks such as polydimethylsiloxane blocks i.e. PDMS, polyolefin blocks, polycarbonate blocks, and combinations thereof. The possible soft blocks are described, for example, in French patent application No.: 0950637, page 32, line 3, to page 38, line 23. As an example, the polyether blocks are chosen among poly(ethylene glycol) (PEG), poly(1,2-propylene glycol) (PPG), poly(1,3-propylene glycol) (PO3G), poly(tetramethylene glycol) (PTMG), and their copolymers or combinations. Preferably, the number-average molecular mass Mn of the soft blocks according to the invention is comprised within the range of from 250 to 5000 g/mol, preferably from 250 to 3000 g/mol, and yet again preferably from 500 to 2000 g/mol.

The hard blocks may be polyamide-based, polyurethane-based, polyester-based, or a combination of these polymers. These blocks are described in particular in French patent application No.: 0856752. Hard blocks are preferably polyamide-based.

Polyamide (PA) blocks can comprise homopolyamides or copolyamides. The possible polyamide blocks in the composition of the invention are in particular those defined in application FR0950637, from page 27, line 18, to page 31, line 14. Preferably, the number-average molecular mass Mn of the polyamide blocks is comprised within the range of from 400 to 20,000 g/mol, preferably from 500 to 10,000 g/mol, and yet again preferably from 600 to 3000 g/mol. Examples of polyamide blocks are those comprising at least one of the following molecules: PA12, PA11, PA10.10, PA6.10, PA6, PA6/12, a copolyamide comprising at least one of the following monomers: 11, 5.4, 5.9, 5.10, 5.12, 5.13, 5.14, 5.16, 5.18, 5.36, 6.4, 6.9, 6.10, 6.12, 6.13, 6.14, 6.16, 6.18, 6.36, 10.4, 10.9, 10.10, 10.12, 10.13, 10.14, 10.16, 10.18, 10.36, 10.T, 12.4, 12.9, 12.10, 12.12, 12.13, 12.14, 12.16, 12.18, 12.36, 12.T and combinations or copolymers thereof.

Advantageously, said at least one block copolymer comprises at least one block chosen among: the polyether blocks; the polyester blocks; the polyamide blocks; the polyurethane blocks; and combinations thereof. Examples of hard-soft block copolymers are, respectively, (a) copolymers with polyester blocks and polyether blocks (also known as COPEs or copolyesterethers), (b) copolymers with polyurethane and polyether blocks (also known as TPUs which is the abbreviation for thermoplastic polyurethanes) and (c) copolymers with polyamide and polyether blocks (also known as PEBAs according to the IUPAC, or as polyether-block-amides).

Preferably, said at least one copolymer comprises a copolymer with polyamide blocks and polyether blocks (PEBA). Advantageously, said PEBA comprises PA12-PEG, PA6-PEG, PA6/12-PEG, PA11-PEG, PA12-PTMG, PA6-PTMG, PA6/12-PTMG, PA11-PTMG, PA12-PEG/PPG, PA6-PEG/PPG, PA6/12-PEG/PPG, PA11-PEG/PPG, PA11/PO3G, PA6.10/PO3G and/or PA10.10/PO3G.

In the present description, and by convention in the field of manufacturing three-dimensional objects by powder agglomeration by melting, the melting temperature (Tm) of the polymer powder that corresponds to the first heating to the melting temperature (Tf1) of the powder. This is measured according to ISO standard 11357-3 “Plastics—Differential Scanning Calorimetry (DSC)”, Part 3. The block copolymer has a melting temperature Tf (first heat: Tf1) of less than 180° C. The use of such copolymers of Tf<180° C. in the composition of the invention allows to obtain, in particular by sintering, three-dimensional objects with improved flexibility (modulus less than 1000 MPa) compared to parts obtained by sintering polyamide 12 or 11 powders, for example.

According to a particular embodiment of the invention, the weight ratio of hard blocks to soft blocks of the copolymer according to the invention is less than 0.7. This allows three-dimensional objects with even better flexibility to be obtained, e.g., with an elasticity modulus of less than 100 MPa and elongation at break greater than 100%, measured according to ISO 527-2: 93-1BA.

“Magnetic particle” within the meaning of the invention, means, within the meaning of the invention the rare earth and/or alnico (Aluminium, Nickel, Cobalt)-based and/or ferrite-based magnetic particles, and a D50 in the range of 0.1 to 100 μm.

For ferrite particles, particles such as magnetoplumbite can be used. Specific examples of magnetoplumbite-type ferrite particles can include barium ferrite particles, strontium ferrite particles and barium-strontium ferrite particles, which are represented by the formula: AOnFe₂O₃ (in which A is Ba, Sr or Ba-Sr; n=5.0 to 6.5), as well as particles obtained by incorporating at least one member selected from the group consisting of Ti, Mn, Al, La, Zn , Bi and Co into these ferrite particles, in an amount of preferably from 0.1 to 7.0 mol %.

The ferrite particles have an average particle diameter of preferably from 1.0 to 5.0 μm, more preferably from 1.0 to 2.0 μm; a specific BET surface area of preferably 1 to 10 m²/g, more preferably 1 to 5 m²/g; a coercive force IHC of preferably from 119-557 kA/m (1500 to 7000 Oe), more preferably from 119-398 kA/m (1500 to 5000 Oe); and a residual magnetization value of preferably from 100 to 300 mT (1000 to 3 000 G), better yet from 100 to 200 mT (1000 to 2000 G).

The magnetic particles are rare earth particles of metal compounds comprising at least one rare earth element and at least one transition metal. Examples of magnetic rare earth particles can include magnetic particles such as cobalt-based rare earth particles, iron-boron-rare-earth-based particles, and iron-nitrogen-rare-earth-based particles. Among these magnetic rare earth particles, the iron-boron-rare-earth-based particles, and iron-nitrogen-rare-earth-based particles are preferred due to the production of bound magnets with excellent magnetic properties.

The rare earth magnetic particles have a D50 of preferably from 1 to 100 μm, more preferably from 1 to 80 μm. A specific BET surface area of preferably from 0.5 to 5 m²/g, more preferably 0.5 to 3 m²/g; a coercive force IHC of preferably from 239 to 1591 kA/m (3.0 to 20 kOe), better yet from 318 to 1114 kA/m (4.0 to 15 kOe); and a residual magnetization value of preferably from 0.3 to 1.8 mT (3.0 to 18 kG), more preferably from 0.5 to 1.3 mT (5.0 to 13 kG).

The Nb-Fe-B-based magnetic particles can be directly mixed into the polymer resin. However, if the Nb-Fe-B-based magnetic particles are in the form of fine flaky particles, the particles are preferably pre-powdered into particles with an average particle diameter of less than or equal to 100 μm before mixing, using for example a jet grinder, an atomiser, a ball grinder, etc. in order to achieve greater fluidity and improved magnetic properties for the resulting powder composition according to the invention.

Advantageously, the magnetic particles used in the powder according to the invention can optionally have undergone various surface treatments to avoid deterioration of their magnetic properties due to oxidation, but this is not mandatory, because the use of a polymer, in particular polyamide, in the composition according to the invention helps limit this problem of oxidation of the metallic particles.

Coatings that can be used in surface treatments of the magnetic particles or magnets include silane-based coupling agents, titane-based coupling agents, aluminium-based coupling agents, siloxane-based coupling agents, surface treatment agents based on organic phosphoric acid, inorganic phosphoric agents, acid-based surface treatment agents, and similar agents. Among these coating materials, silane-based coupling agents are preferred.

The powder composition according to the invention can be obtained using different methods, such as:
dry blending of a polyamide powder and a magnetic powder, optionally comprising additives (modifiers, UV stabilsers, heat stabilisers, anti-oxidants, fillers, unmoulding agents, pigments, coupling agents, reinforcement materials such as talc or fiberglass, lubricants, etc.)
extrusion of a polyamide powder and a magnetic powder, optionally comprising additives (modifiers, UV stabilsers, heat stabilisers, anti-oxidants, fillers, unmoulding agents, pigments, coupling agents, reinforcement materials such as talc or fiberglass, lubricants, etc.) and then grinding in order to obtain a powder with a granulometry (D50) comprised within the range of 0.1 and 100 μm.

Optionally, one or more additives can be added to this ground powder, chosen among: flow aids, stabilisers, coupling agents, etc.

Advantageously, the composition in the invention also comprises a flow aid in sufficient amounts (representing from 0.1 to 5% by weight for the composition) such that the composition flows and forms a level layer, in particular in the layered sintering process. The flow agent is chosen among those commonly used in the field of sintering polymer powders. Preferably, this flow agent is of substantially spherical shape. It can be chosen, for example, from: the silicas, precipitated silicas, hydrated silicas, vitreous silicas, fumed silicas, pyrogenic silicas, glassy phosphates, glassy borates, glassy oxides, amorphous aluminium, titanium dioxide, talc, mica, kaolin, attapulgite, calcium silicates, alumina, and magnesium silicates.

The compositions according to the invention may of course also comprise any type of suitable additive polymer powders used in sintering, in particular, additives that help to improve the powder properties for use in agglomeration technology and/or additives to improve the mechanical (stress at break and elongation at break) or aesthetic (colour) properties of the objects obtained by melting. The composition of the invention can in particular comprise dyes, colouring pigments, TiO2, pigments for infrared absorption, carbon black, fire-resistant additives, glass fibers, carbon fibers, etc. The compositions of the invention can also contain at least one additive selected from antioxidant stabilisers, light stabilisers, anti-shock agents, antistatic agents, flame retardants, and mixtures thereof. These additives are in powder form with D50 less than 20 μm. The introduction of these additives in the manufacturing method used for the powder composition according to the invention improves their dispersion and effectiveness. A sintering process using a composition according to the invention enables colored magnetic parts to be directly obtained without subsequent operations, coating or paint.

The present invention also relates to the use of a thermoplastic powder composition as defined above, in a sintering process for producing a magnetic object. The present invention also relates to a method of manufacturing a three-dimensional magnetic object, comprising layered sintering of a powder of a composition according to the invention.

The present invention particularly relates to method for manufacturing three-dimensional parts from a powder according to the invention, by a layering process wherein areas of the respective powder layers are selectively melted via introduction of electromagnetic energy in which the selectivity is obtained by the use of susceptors, of inhibitors, or via masks. These include for example all methods such as those more commonly known under the brand names: Selective Laser Sintering, SLS, or any high-speed sintering type processes, such as those known by the terms: HSS Multi Jet Fusion MJF by HP, selective sintering by means of a mask, SMS sintering, selective hot sintering SHS, etc.

Preferably, said method uses laser sintering.

The present invention relates to a three-dimensional magnetic object likely to be manufactured according to the method described above, said object having the following properties:
intrinsic coercivity Hci =1 to 15 kOe; and or
Remanence Br =0.3 to 1.8 T

In accordance with MMPA STANDARD No. 0100-00;
IZOD Impact resistance comprised within the range of from 10 to 30 kJ/m² in accordance with ISO 180: 2000 at 23° C.; and/or
Flexural modulus comprised within the range of from 50 to 200 MPa in accordance with ISO 178: 2010.

Advantageously, said three-dimensional object is a component used in sports equipment, shoes, sports shoes, shoe soles, decoration, luggage, glasses, furniture, audiovisual equipment, computer equipment automobile or aircraft and/or a part used in medical equipment, household appliances, computers, electronics and/or microelectronics.

Articles obtained by sintering according to the invention have the following advantageous properties:
Modulus superior to a part obtained by injection;
Parts having complex designs can be obtained, with the possibility of making articulated parts or including elements;
Accelerated development time (no need to mould unlike with injection); And, compared to purely metallic metal pieces obtained by sintering:
Better mechanical properties: impact resistance, flexibility, elongation at break;
Corrosion resistance.

1. A sinterable magnetic powder composition comprising:
from 50 to 95% by weight of at least one powder magnet;
from 5 to 50% by weight of at least one thermoplastic polymer;
for the total weight of the composition.
said powder composition having a D50 comprised within the range of 0.1 to 100 μm.

2. The composition according to claim 1, wherein said at least one copolymer is chosen among: the polyamides, the polyolefins, the epoxies and polyesters, the epoxy/polyether hybrids, the polyurethanes, the block copolymers, and the poly(arylene-ether-ketones), and combinations thereof.

3. The composition according to claim 1, wherein said at least one magnet powder is selected from rare earth-based- and/or alnico- and/or ferrite-based particles, and D50 is comprised within the range of from 0.1 to 100 μm.

4. A manufacturing process for a powder composition as defined in claim 1 comprising the following steps:
a) mixing by compounding said at least one polymer with said at least one magnet;
b) grinding the mixture obtained in a) to obtain a powder with a D50 of less than 100 μm and a yield greater than 50%;
c) optional addition of additives such as a flow aid, to the powder obtained in b).

5. The method of manufacturing a powder composition according to claim 1 comprising dry mixing a powder of said polymer and said magnet powder.

6. The method of manufacturing a powder composition according to claim 1 to manufacture a magnetic object by sintering.

7. The composition according to claim 1, also comprising a flow aid selected among silicas, hydrated silicas, amorphous aluminium, glassy silicas, glassy phosphates, glassy borates, glassy oxides, titanium dioxide, talc, mica, fumed silicas, pyrogenated silicas, kaolin, attapulgite, calcium silicates, aluminium and magnesium silicates.

8. A method of manufacturing a three-dimensional magnetic object comprising the layered sintering of a powder of a composition according to claim 1.

9. A three-dimensional magnetic object manufactured according to the method of claim 8, said object having at least one of the following properties:
intrinsic coercivity Hci=1 to 15 kOe; and or
remanence Br=0.3 to 1.8 T
in accordance with MMPA STANDARD No. 0100-00;
IZOD Impact resistance comprised within the range of from 10 to 30 kJ/m² in accordance with ISO 180:2000 at 23° C.; and/or
flexural modulus comprised within the range of from 50 to 200 MPa in accordance with ISO 178: 2010.

10. The object according to claim 9, said object being a component used in sports equipment, shoes, sports shoes, shoe soles, decoration, luggage, glasses, furniture, audiovisual equipment, computer equipment automobile or aircraft and/or a part used in medical equipment, household appliances, computers, electronics and/or microelectronics.
